(19) United States
(12) Patent Application Publication
(10) Pub. No.: US 2024/0019653 A1
(43) Pub. Date: Jan. 18, 2024

(54) BRACKET FOR OPTICAL NETWORK TERMINAL

(71) Applicant: Q Comm IP, LLC, Evansville, IN (US)

(72) Inventors: James S. Derk, Eddyville, KY (US); James G. Lowe, Evansville, IN (US)

(21) Appl. No.: 18/221,109

(22) Filed: Jul. 12, 2023

Related U.S. Application Data
(60) Provisional application No. 63/389,595, filed on Jul. 15, 2022.

(51) Int. Cl. G02B 6/44

(52) U.S. Cl. CPC G02B 6/4446; G02B 6/4457; G02B 6/44524

(57) ABSTRACT

A bracket for an optical network terminal is described. The bracket includes cable management features to store a fiber optic cable that connects to the optical network terminal. The bracket includes a holding region configured to receive and hold an optical network terminal. A rear of bracket includes a fiber cable spool configured to position a fiber cable. A port passes through the bracket for the fiber cable to pass form the fiber cable spool to the optical network terminal.

This application claims priority to U.S. Provisional Application No. 63/389,595 filed Jul. 15, 2022, which is hereby incorporated by reference in its entirety.

### FIELD OF INVENTION

The present invention relates to a bracket for an optical network terminal.

### SUMMARY OF INVENTION

A bracket for an optical network terminal is described. The bracket includes cable management features to store a fiber optic cable that connects to the optical network terminal. The bracket helps to prevent crimps and sharp bends in the cable that may damage the cable. The bracket stores or holds the cable without exceeding a bend tolerance of the cable. The bracket includes a cover to prevent or reduce consumer contact with the fiber optic cable. The bracket may secure the optical network terminal to a wall or other vertically orientated structure.

In one aspect, a bracket for an optical network terminal is described. The bracket includes a central wall and an outer wall. The central wall and the outer wall define a holding region configured to receive and hold an optical network terminal on a front side of the bracket. A first fiber cable spool is on a rear side of the bracket. The first fiber cable spool is configured to position a fiber cable. A second fiber cable spool is on the rear side of the bracket. The second fiber cable spool is configured to position the fiber cable. A port is configured to pass the fiber cable to the optical network terminal.

In another aspect, a bracket for an optical network terminal is described. The bracket includes a central wall comprising a front surface and a rear surface. The bracket includes an outer wall. The central wall and the outer wall define a holding region configured to receive and hold an optical network terminal. The rear surface of the central wall comprises a fiber cable spool configured to position a fiber cable. A port passes through the central wall. The port is configured to pass the fiber cable from the fiber cable spool to the optical network terminal.

In another aspect, a bracket for an optical network terminal is described. The bracket includes a central wall and an outer wall. The central wall and the outer wall define a holding region configured to receive and hold an optical network terminal. A fiber cable spool is positioned on a rear side of the bracket. The fiber cable spool is configured to position a fiber cable. A port passes through the central wall. The port is configured to pass the fiber cable from the fiber cable spool to a front side of the bracket. A protective cover is configured to engage the front side of the bracket to cover the port and a portion of the fiber cable. A sliding cover is configured to slidably engage with the bracket and to cover the protective cover.

In another aspect, a bracket for an optical network terminal is described. The bracket includes a central wall and an outer wall. The central wall and the outer wall define a holding region configured to receive and hold an optical network terminal. A fiber cable spool is positioned on a rear side of the bracket. The fiber cable spool is configured to position a fiber cable and a pigtail of fiber cable. A port passes through the bracket. The port is configured to pass the pigtail of fiber cable to a front side of the bracket. A protective cover is configured to engage the front side of the bracket to cover the port and a portion of the fiber cable. A cover is configured to engage with the bracket and to cover the protective cover.

### BRIEF DESCRIPTION OF DRAWINGS

FIG. 1 is a perspective view of the optical network terminal engaged to the bracket.

FIG. 2 is a perspective view of the bracket.

FIG. 3 is a front view of the bracket.

FIG. 4 is a side view of the optical network terminal engaged to the bracket, and the bracket engaged to the mount.

FIG. 5 is a front view of the optical network terminal engaged to the bracket.

FIG. 6 is a front perspective view of the bracket with the sliding cover and the protective cover disengaged.

FIG. 7 is a rear perspective view of the bracket with the sliding cover and the protective cover disengaged.

FIG. 8 is a side view of the sliding cover ready to engage the bracket.

FIG. 9 is a side view of the sliding cover engaged to the bracket.

FIG. 10 is a perspective view of the protective cover ready to engage the bracket.

### DETAILED DESCRIPTION OF INVENTION

For purposes of this application, any terms that describe relative position (e.g., “upper”, “middle”, “lower”, “outer”, “inner”, “above”, “below”, “bottom”, “top”, etc.) refer to an embodiment of the invention as illustrated, but those terms do not limit the orientation in which the embodiments can be used.

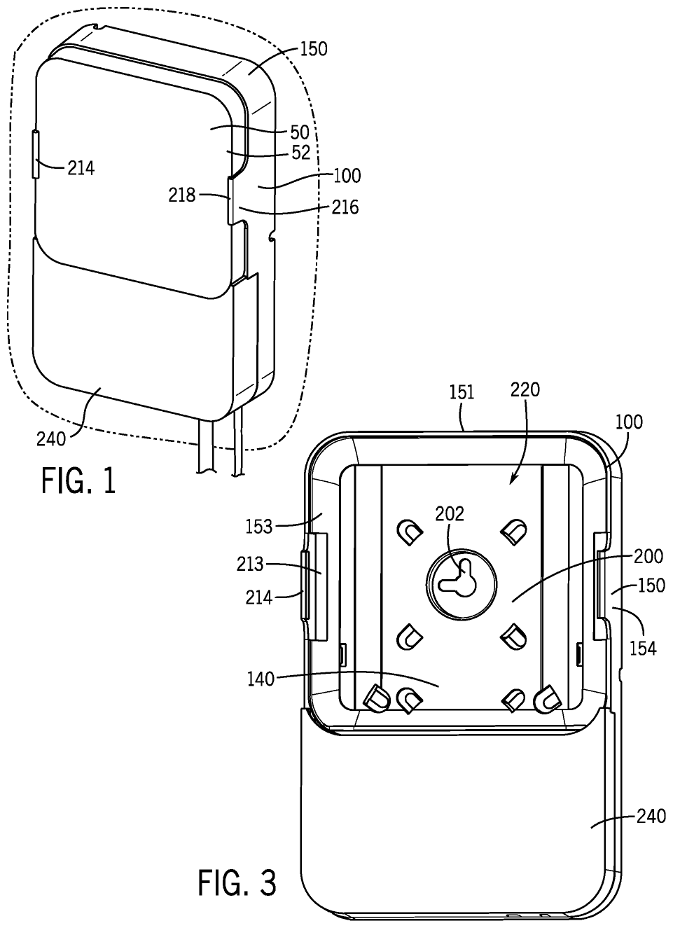

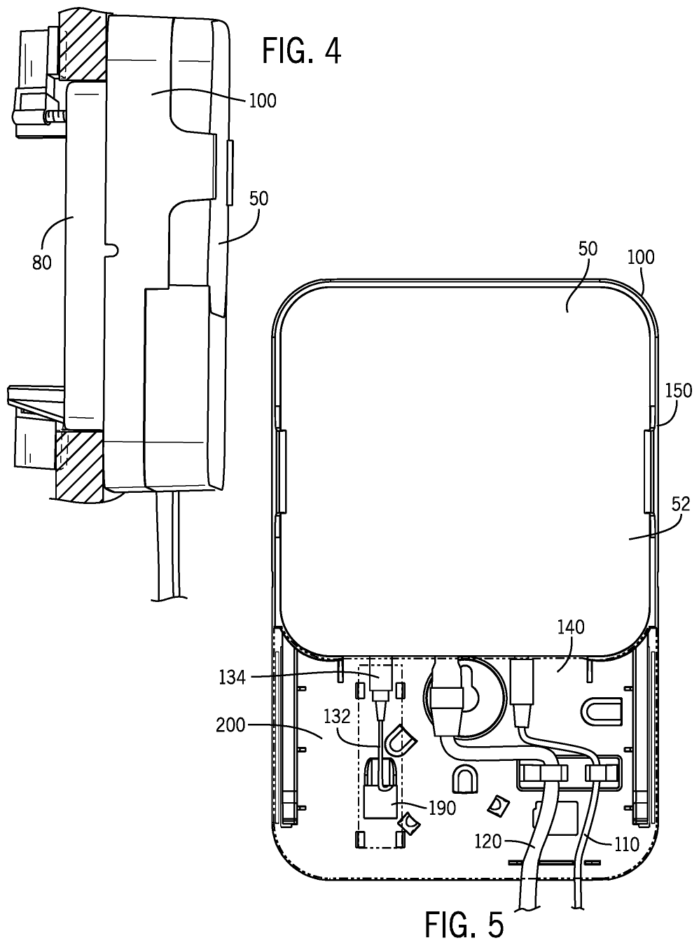

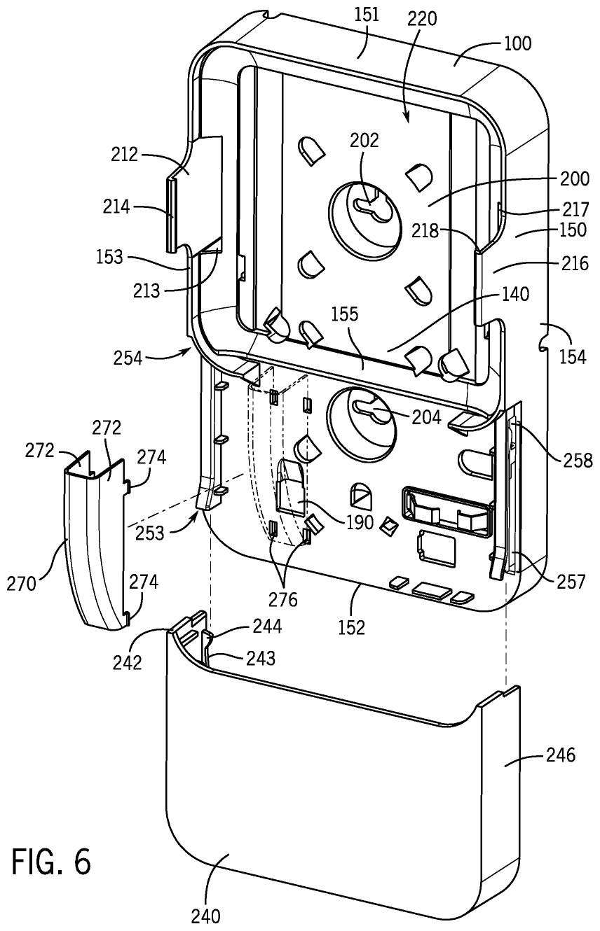

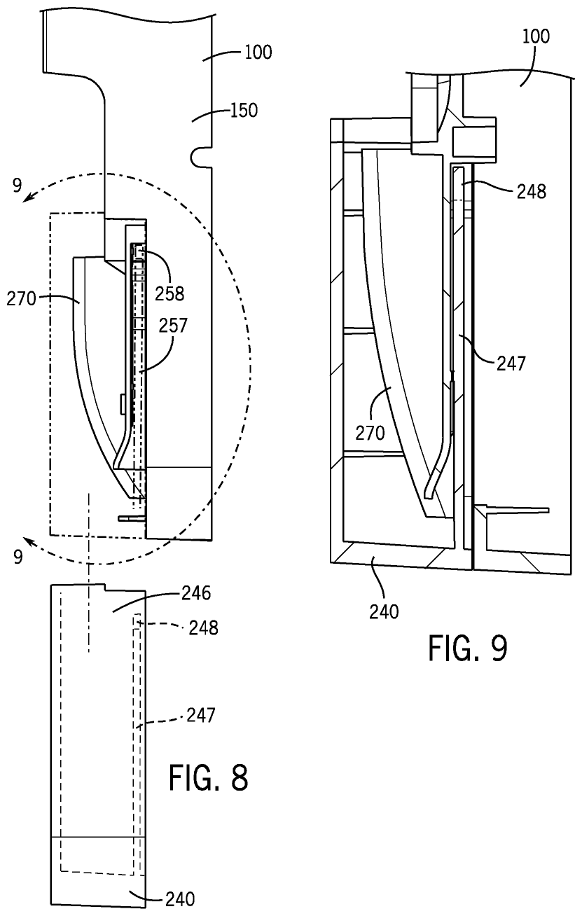

With references to FIGS. 1-10, a bracket 100 for an optical network terminal 50 will now be described. The bracket 100 engages to a mount 80, which may be mounted or fastened to a wall or other vertically orientated structure. Of course, in certain instances, the bracket 100 may installed or rested in a horizontal manner or other angle. The optical network terminal 50 removably engages to the bracket 100.

During installation of a fiber cable system, an interior line 130 of fiber cable is supplied to the mount 80. The interior line 130 may have been fished through interior walls, ceilings, etc. At the bracket 100, the interior line 130 is spliced to a pigtail 132 of fiber optic cable or other short lead of fiber optic cable. The pigtail 132 of fiber optic cable will generally already include a factory-installed SC/APC connector 134, which plugs into a port of the optical network terminal 50.

The bracket 100 includes multiple features and components to protect the interior line 130 and the pigtail 132. In general, fiber optic cable is fragile and may be inadvertently crimped, overly bent, or broken, which leads to failures in the fiber optic cable. The bracket 100 helps to prevent crimping, twists, or sharp bends in the interior line 130 and the pigtail 132. During installation of the fiber cable system, there may be an extra amount of the interior line 130 and/or pigtail 132. For example, there may be several feet of extra interior line 130. The bracket 100 provides cable management features to conveniently store the fiber optic lines that do not exceed bend tolerance of the fiber optic lines. The bracket 100 provides cable management features to reduce crimps, twists, or sharp bends. The bracket 100 provides cable management features to safely store or house an extra amount of the incoming interior line 130. The end of the incoming interior line 130 is pre-polished in order to splice to the pigtail 132. As such, merely trimming or cutting the extra incoming line 130 would require refinishing or repolishing the end of the incoming interior line 130.

In a typical installation, the optical network terminal 50 is inserted into the bracket 100 and engaged to a power supply line 110, an ethernet cable 120 or other data transmission line, and the pigtail 132 via the SC/APC connector 134. The bracket 100 holds the optical network terminal 50 in position.

With respect to FIGS. 3, 5, and 6, a front surface 200 of a central wall 140 of the bracket 100 is shown. An outer wall 150 forms a periphery of the bracket 100. In this aspect, the outer wall 150 includes a top wall portion 151 generally opposite of a bottom wall portion 152, and a left wall portion 153 generally opposite of a right wall portion 154, which, in this aspect, together form a generally rectangular shape with rounded corners.

The front surface 200 of the bracket 100 includes an upper mounting slot 202 and a lower mounting slot 204. The slots 202 and 204 pass through the central wall 140. Fasteners, such as screws, may pass through the upper mounting slot 202 and the lower mounting slot 204 to hold the bracket 100 to the mount 80. The bracket 100 may be mounted in both vertical and horizontal positions. The slots 202 and 204 include a perpendicular shape to accommodate the vertical and horizontal positions. When installed in a vertical manner, the rear surface 300 of the bracket 100 may be positioned against a front surface of the mount 80, while a rear surface of the mount 80 may positioned against a surface of a wall or other vertical surface.

In this aspect, the outer wall 150 defines or partially defines a holding region 220 configured to receive and hold the optical network terminal 50. The holding region 220 is generally formed at an upper portion of the bracket 100. The holding region 220 is sized and shaped to be just larger than an outer diameter of the optical network terminal 50. In this aspect, portions of the top wall portion 151, the left wall portion 153, and the right wall portion 154, along with an interior wall 155, form the holding region 220. The optical network terminal 50 may snap or press-fit into the holding region 220.

On a front side of the bracket 100, the outer wall 150 includes a first fastening clip 212 and a second fastening clip 216. A first relief opening 213 is positioned proximate the first fastening clip 212. A second relief opening 217 is positioned proximate the second fastening clip 216. In this aspect, the first fastening clip 212 extends from the left wall portion 153 and the second fastening clip 216 extends from the right wall portion 154. In this aspect, the first fastening clip 212 and the second fastening clip 216 are integral with the left wall portion 153 and the right wall portion 154, respectively. The first fastening clip 212 and the second fastening clip 216 further include a first tab 214 and a second tab 218, respectively, that hold against a front surface 52 of the optical network terminal 50. The first fastening clip 212 and the 216 are resiliently flexible to hold the optical network terminal 50 in the holding region 220. A user may bend or urge the first fastening clip 212 and the second fastening clip 216 outward to remove the optical network terminal 50 from the holding region 220. In other aspects, the optical network terminal 50 may be strapped to the bracket 100 or held in place in the bracket 100 with fasteners.

In the illustrated aspect, the bracket 100 includes at least one holder 230, which is configured to hold a heat shrink glass tube 232 for splicing the incoming interior line 130 and the pigtail 132. During the installation, ends of the interior line 130 and the pigtail 132 are inserted into the heat shrink glass tube 232 and heat is applied to form the splice. After the splice is formed in the glass tube 232, the least one holder 230 may still hold the glass tube 232, which helps to prevent stress to the splice. In the aspect shown in the Figures, the front surface 200 includes two holders 230, which are positioned on opposite, lateral sides of the front surface 200 to provide flexibility during the installation.

In this aspect, a sliding cover 240 covers a lower portion of the front surface 200 of the bracket 100. The sliding cover 240 slidably engages to the bracket 100 in a removable fashion. The sliding cover 240 covers up, hides, and/or protects the power supply line 110, ethernet cable 120, and the pigtail 132. The sliding cover 240 helps to prevent accidental interference with the power supply line 110, ethernet cable 120, and the pigtail 132. The sliding cover 240 provide a cleaner look and appearance to the bracket 100. In other aspects, a snap fit, press-fit or other locking cover may be used instead of the sliding cover 240.

The sliding cover 240 includes a first lateral wall 242 and a second lateral wall 246. The first lateral wall 242 include an inwardly extending flange 243, and the second lateral wall 246 includes an inwardly extending flange 247. When the sliding cover 240 is slidably engaged to the bracket 100, the inwardly extending flange 243 enters a first track 253, and the inwardly extending flange 247 enters a second track 257. In this aspect, the flanges 243 and 247 include flange extensions 244 and 248, respectively, which seat or snap into deeper portions 254 and 258 of the tracks 253, and 257, respectively. The sliding cover 240 further includes a cut-out 245 for the ethernet cable 120 and a cut-out 249 for the power supply line 110 to provide a flush closing to the sliding cover 240.

In this aspect, a protective cover 270 also engages to the front surface 200 of the bracket 100. The protective cover 270 is shaped and configured to cover and/or protect the SC/ACP connector 134 of the pigtail 132 and the pigtail 132. The protective cover 270 helps prevent damages to the pigtail 132 or the SC/APC connector 134. The protective cover 270 helps to prevent the consumer from touching or manipulating the pigtail 132. The protective cover 270 helps to protect the consumer from accidentally hurting themselves with light emitted from the pigtail 132. However, the sliding cover 240 may be slid downward to permit the user to access a power button of the optical network terminal 50 for restarting the optical network terminal 50 or to insert/remove the ethernet cable 120 and/or the power supply line 110.

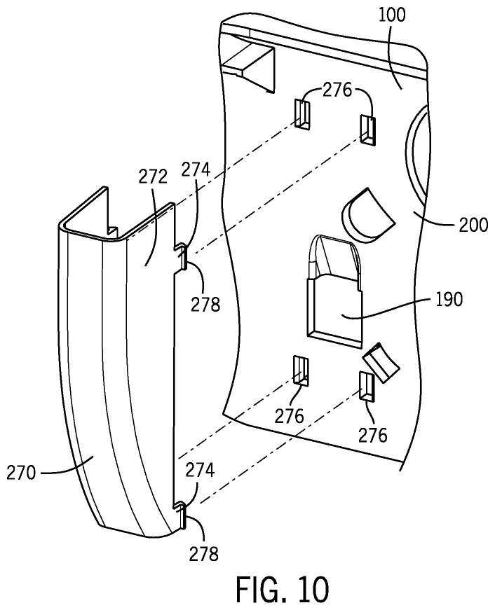

The protective cover 270 also covers a port 190 in the front surface 200. The pigtail 132 passes from a rear side of the bracket 100 to the front side of the bracket 100 by passing through the port 190. The protective cover 270 includes lateral walls 272 forming extending portions 274 that engage openings 276 in the front surface 200 to hold or snap the protective cover 270 to the front surface 200. In this aspect, the protective cover 270 includes four extending portions 274 that fit into four openings 276. With respect to FIG. 10, the portions 274 includes tabs 278 that extend outward. The lateral walls 272 may be squeezed inwardly by the user to engage the extending portions 274 with the openings 276, and then the lateral walls 272 may flex outward when released, with the tabs 278 holding against the rear surface 300.

The front surface 200 of the bracket 100 further includes a first clip 181 to secure the power supply line 110 and a second clip to secure the ethernet cable 120.

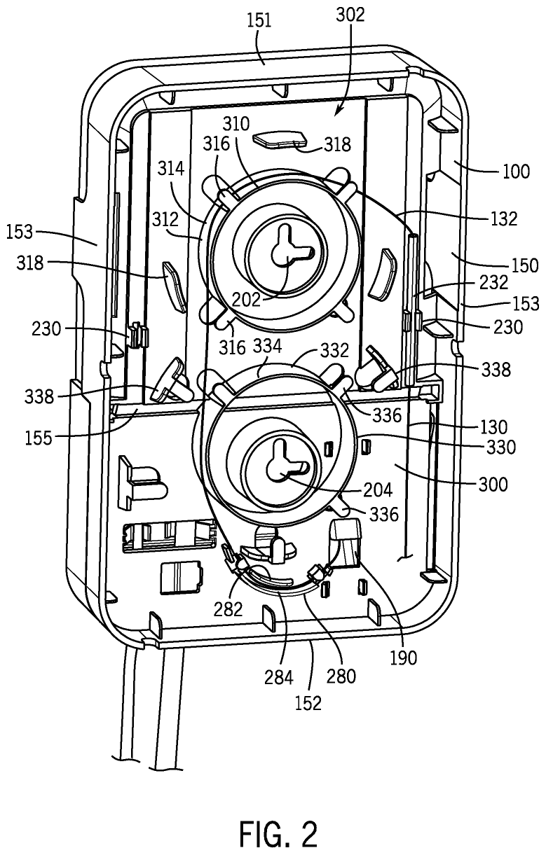

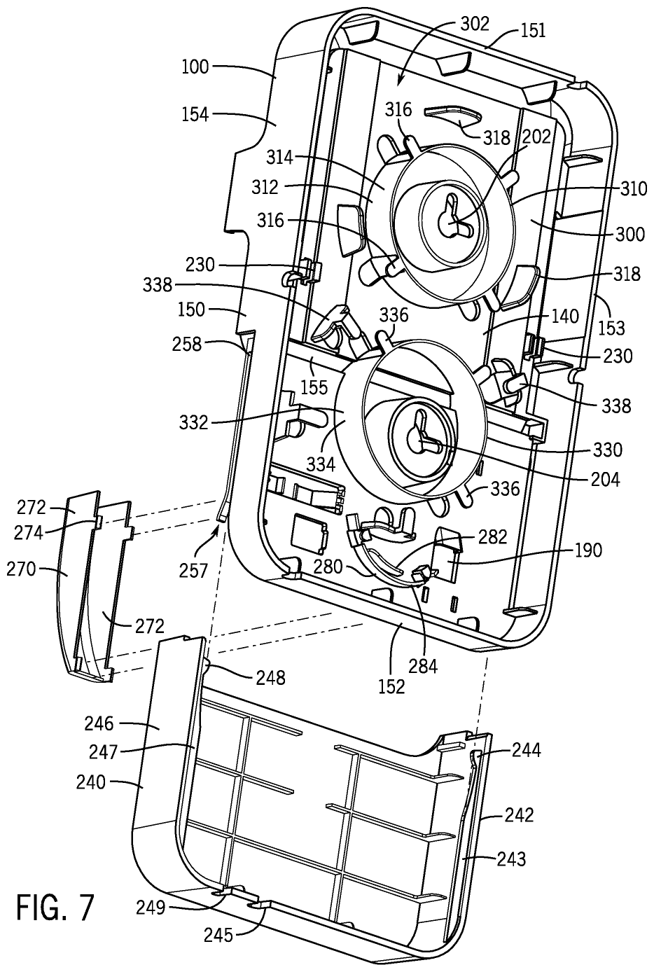

With respect to FIGS. 2 and 7, a rear surface 300 of the bracket 100 is shown. The outer wall 150 may extend from the rear surface 300. The outer wall 150 may define or partially define a rear interior 302 of the rear surface 300

The rear surface 300 includes a first fiber cable spool 310 and a second fiber cable spool 330. The first and second fiber cable spools 310 and 330 include walls 312 and 332 with cylindrical outer surfaces, 314 and 334, respectively. The interior line 130 and the pigtail 132 may wrap against or proximate one or both of the outer surfaces 314 and 334. The walls 312 and 332 have a depth sufficient to contact a wall or mounting surface to which the bracket 100 is mounted. This helps to prevent the interior line 130 and the pigtail 132 from getting caught between the bracket 100 and the mounting surface. Depending upon the length of the interior line 130, the interior line 130 may wrap against, around or partially around one or both of the first fiber cable spool 310 and the second fiber cable spool 330. This prevents crimping, twists, or sharp bends in the interior line 130 and the pigtail 132. The first fiber cable spool 310 and the second fiber cable spool 330 are shaped and sized such that the bend tolerance of the interior line 130 and/or the pigtail 132 is not exceeded. In this aspect, the slot 202 is generally centered in the first fiber cable spool 310 and the slot 204 is generally centered in the second fiber cable spool 330.

In other aspects, the first fiber cable spool 310 and the second fiber cable spool 330 may be merged or integral with each other such that the rear surface 300 includes a singular ovular or stadium shaped cable spool. In such aspect, the walls 312 and 332 of the first and second fiber cable spools 310 and 330 may join or lead into each other. In other aspects, one of the first fiber cable spool 310 and the second fiber cable spool 330 may be omitted. Of course, this may lessen the overall fiber storage capacity. In other aspects, a third cable spool may be used along with the first fiber cable spool 310 and the second fiber cable spool 330,

The interior line 130 and/or the pigtail 132 wrap against the cylindrical outer surfaces 314 and 334 of the walls 312 and 332 of the first and second fiber cable spools 310 and 330. The outer surfaces 314 and 334 are typically sized and shaped to have a bend radius ratio of less than 65%. In certain aspects, the outer surfaces 314 and 334 are sized and shaped to have a bend radius ratio of approximately 10% to approximately 35%. In the aspect of FIGS. 1-10, the outer surfaces 314 and 334 are sized and shaped to have a bend radius ratio of approximately 20%. In the aspect of FIGS. 1-10, the walls 312 and 332 have an outer diameter of approximately two inches. In other aspects, the walls 312 and 332 may have an outer diameter of approximately one inch to approximately 6 inches. Of course, the size and outer diameter may be scaled up or down depending upon the size of the bracket 100, specific bend tolerances, size of the interior line 130 and/or the pigtail 132, the length of the lines 130 and 132 to be stored, etc.

The first fiber cable spool 310 include one or more tabs 316 extending outwardly from the wall 312. The tabs 316 assist in maintaining the interior line 130 and/or the pigtail 132 in close proximity to the wall 312. Similarly, the second fiber cable spool 330 include one or more tabs 336 extending outwardly from the wall 332. The tabs 336 assist in maintaining the interior line 130 and/or the pigtail 132 in close proximity to the wall 332.

The rear surface 300 may further include one or more positioners 318 extending outward from the rear surface 300 in close proximity to the first fiber cable spool 310. The positioners 318 also assist in maintaining the interior line 130 and/or the pigtail 132 in close proximity to the wall 312,

Similarly, the rear surface 300 may further include one or more positioners 338 extending outward from the rear surface 300 in close proximity to the second fiber cable spool 330. The positioners 318 also assist in maintaining the interior line 130 and/or the pigtail 132 in close proximity to the wall 332.

The rear surface 300 may further include a rounded positioner 280 that directs the pigtail 132 to the port 190 in the bracket 100. The port 190 forms an opening completing through the bracket 100. The port 190 provides for the pigtail 132 to pass from a rear of the bracket 100 to the front of the bracket 100. The rounded positioner 280 extends from the rear surface 300. The rounded positioner 280 include an inner rounded positioner 282 that forms a curved channel 284 to position the pigtail 132 as the pigtail 132 approaches the port 190. The rounded positioner 280 assists in maintain a proper bend tolerance.

With respect to FIG. 2, the interior line 130 and the pigtail 132 are shown installed on the bracket 100. The incoming interior line 130 may pass through or from the mount 80 or other structure into the rear interior 302 of the rear surface 300 of the bracket 100. The interior line 130 is then spliced to the pigtail 132 in the heat shrink glass tube 232. The heat shrink glass tube 232 is positioned in the holder 230. Next, the pigtail 132 is positioned against or partially wrapped around the cylindrical outer surface 314 of the first fiber cable spool 310. Next, the pigtail 132 is positioned against or partially wrapped around the cylindrical outer surface 334 of the second cable spool 330. Next, the pigtail 132 passes against or proximate the rounded positioner 280 that directs the pigtail 132 to the port 190 that leads to the front side of the bracket 100, as shown in FIG. 5, where the connector 134 of the pigtail 132 connects to the optical network terminal 50.

The optical network terminal 50 converts pulse of light from the interior line 130, which is connected to a fiber optic network, to electrical signals. The optical network terminal 50 include processors to convert the pulses of light to the electrical signals that are output via ethernet or other wiring. The optical network terminal 50 may electrically connect with a router or other computer equipment. In this aspect, the optical network terminal 50 includes the power supply line 130 and the ethernet cable 120.

In other aspects, the bracket 100 may engaged directly to the wall or other vertically orientated structure. As such, in these aspects, the mount 80 is not utilized.

As such, it should be understood that the disclosure is not limited to the particular aspects described herein, but that various changes and modifications may be made without departing from the spirit and scope of this novel concept as defined by the following claims. Further, many other advantages of applicant's disclosure will be apparent to those skilled in the art from the above descriptions and the claims below.

What is claimed is:

1. A bracket for an optical network terminal, comprising:
a central wall;
an outer wall;
the central wall and the outer wall defining a holding region configured to receive and hold an optical network terminal on a front side of the bracket;
a first fiber cable spool on a rear side of the bracket, the first fiber cable spool configured to position a fiber cable;
a second fiber cable spool on the rear side of the bracket, the second fiber cable spool configured to position the fiber cable; and
a port, the port configured to pass the fiber cable to the optical network terminal.

2. The bracket for an optical network according to claim 1, wherein the bracket provides cable management features that do not exceed bend tolerance of the fiber cable.

3. The bracket for an optical network according to claim 1, wherein the bracket is configured to be mounted or fastened to a wall or other vertically orientated structure in a vertical orientation.

4. The bracket for an optical network according to claim 1, further comprising a cover, the cover configured to engage with the bracket, the cover configured to cover ports on the optical network terminal for power, ethernet, and the fiber cable.

5. The bracket for an optical network according to claim 1, further comprising a protective cover, the protective cover configured to engage the front side of the bracket to cover the port and a portion of the fiber cable.

6. The bracket for an optical network according to claim 5, further comprising a sliding cover, the sliding cover configured to slidably engage with the bracket and to cover the protective cover.

7. The bracket for an optical network according to claim 1, wherein the outer wall includes a first fastening clip and a second fastening clip configured to hold the optical network terminal.

8. The bracket for an optical network according to claim 7, wherein the first fastening clip extends from a left wall portion of the outer wall, and the second fastening clip extends from a right wall portion of the outer wall, the first fastening clip and the second fastening clip further include tabs configured to hold against a front surface of the optical network terminal.

9. The bracket for an optical network according to claim 1, wherein the first and second fiber cable spools include walls with cylindrical outer surfaces.

10. The bracket for an optical network according to claim 9, wherein the fiber cable or a pigtail of the fiber cable wraps against or proximate one or both of the cylindrical outer surfaces.

11. The bracket for an optical network according to claim 9, wherein the cylindrical outer surfaces are shaped and sized such that a bend tolerance of the fiber cable is not exceeded.

12. The bracket for an optical network according to claim 1, wherein a first mounting slot is generally centered in the first fiber cable spool and a second mounting slot is generally centered in the second fiber cable spool.

13. The bracket for an optical network according to claim 1, wherein a rear surface of the bracket includes a rounded positioner that directs the fiber cable to the port in the bracket.

14. The bracket for an optical network according to claim 13, wherein the rounded positioner extends from the rear surface, and the rounded positioner includes an inner rounded positioner that forms a curved channel to position the fiber cable as the fiber cable approaches the port.

15. The bracket for an optical network according to claim 1, wherein the bracket receives the fiber cable, and a pigtail of the fiber cable comprising a SC/AOC connector is spliced to the fiber cable.

16. The bracket for an optical network according to claim 1, wherein the bracket includes a holder, which holds a heat shrink glass tube for splicing the fiber cable and a pigtail of the fiber cable.

17. The bracket for an optical network according to claim 1, wherein outer surfaces of the first fiber cable spool and the second fiber cable spool are sized and shaped to have a bend radius ratio of approximately 10% to approximately 35%.

18. The bracket for an optical network according to claim 1, wherein the optical network terminal is positioned in the holding region.

19. A bracket for an optical network terminal, comprising:
a central wall comprising a front surface and a rear surface;
an outer wall;
the central wall and the outer wall defining a holding region configured to receive and hold an optical network terminal;
the rear surface of the central wall comprising a fiber cable spool configured to position a fiber cable; and
a port passing through the central wall, the port configured to pass the fiber cable from the fiber cable spool to the optical network terminal.

20. A bracket for an optical network terminal, comprising:
a central wall;
an outer wall;
the central wall and the outer wall defining a holding region configured to receive and hold an optical network terminal;
a fiber cable spool positioned on a rear side of the bracket, the fiber cable spool configured to position a fiber cable;
a port passing through the central wall, the port configured to pass the fiber cable from the fiber cable spool to a front side of the bracket;
a protective cover, the protective cover configured to engage the front side of the bracket to cover the port and a portion of the fiber cable; and
a sliding cover, the sliding cover configured to slidably engage with the bracket and to cover the protective cover.

21. A bracket for an optical network terminal, comprising:
a central wall;
an outer wall;
the central wall and the outer wall defining a holding region configured to receive and hold an optical network terminal;
a fiber cable spool positioned on a rear side of the bracket, the fiber cable spool configured to position a fiber cable and a pigtail of fiber cable;
a port passing through the bracket, the port configured to pass the pigtail of fiber cable to a front side of the bracket;
a protective cover, the protective cover configured to engage the front side of the bracket to cover the port and a portion of the fiber cable; and
a cover, the cover configured to engage with the bracket and to cover the protective cover.
